(19) United States
(12) Patent Application Publication
(10) Pub. No.: US 2003/0011764 A1
(43) Pub. Date: Jan. 16, 2003

(54) Blanking standard for non-invasive optical measurement

(76) Inventors: James R. Braig, Piedmont, CA (US); Julian M. Cortella, Alameda, CA (US); Mike A. Munrow, Belmont, CA (US); Kenneth G. Witte, San Jose, CA (US); Heidi M. Smith, Union City, CA (US); Philip C. Hartstein, Cupertino, CA (US); Roger O. Herrera, Emeryville, CA (US); Peter Rule, Los Altos Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/971,312

(22) Filed: Oct. 3, 2001

Related U.S. Application Data
(60) Provisional application No. 60/304,847, filed on Jul. 11, 2001.

(51) Int. Cl. G01J 1/10

(52) U.S. Cl. 356/243.5

(57) ABSTRACT

In accordance with one embodiment there is provided a method of providing a known spectrum to a noninvasive optical detection system of the type having a window for receiving infrared energy. The method comprises affixing a standard to the window. The standard comprises a body formed from a material having known and stable spectral properties. The method further comprises placing at least a portion of the body directly against the window, and operating the optical detection system to detect an emission spectrum of the body. In accordance with another embodiment an infrared spectrometer comprises a window for receiving infrared energy. The window has an exposed surface. The infrared spectrometer further comprises a standard comprising a body formed of a material having known and stable spectral properties. At least part of the body is removably disposed directly against the exposed surface of the window.

### RELATED APPLICATIONS

This application claims priority to U.S. Provisional Patent Application No. 60/304,847, filed Jul. 11, 2001, entitled BLANKING STANDARD FOR NON-INVASIVE OPTICAL MEASUREMENT SYSTEM, the entire contents of which are hereby incorporated by reference.

### BACKGROUND OF THE INVENTION

1. Field of the Invention

The present invention relates to non-invasive optical measurement systems and devices for providing a known spectrum for detection by such systems.

2. Description of the Related Art

Significant advances have been made recently in technology relating to the noninvasive measurement of human tissue constituents, such as the concentration of glucose in the blood and in other fluids, such as interstitial fluid in body tissues. These advances have included absorption spectrometers which detect the intensity of infrared energy emitted from within the body at wavelengths selected to highlight or isolate the absorptive effects of the analyte of interest, or which emit infrared or other energy into the patient's tissue and measure the reflection or return from the tissue.

The accuracy of these devices can often degrade over time, due to phenomena such as “instrument drift,” which is characterized by gradual and unintentional changes in the physical properties of the materials used to construct the device. These changes can introduce an offset or error in the measurements made. Furthermore, other factors, such as room and device temperature, humidity, or patient-specific factors such as skin hydration level, can induce such an offset or error. In order to preserve the accuracy of the measurement device, it is necessary to correct for this offset or error.

### SUMMARY OF THE INVENTION

In accordance with one embodiment there is provided a method of providing a known spectrum to a noninvasive optical detection system of the type having a window for receiving infrared energy. The method comprises affixing a standard to the window. The standard comprises a body formed from a material having known and stable spectral properties. The method further comprises placing at least a portion of the body directly against the window, and operating the optical detection system to detect an emission spectrum of the body.

In accordance with another embodiment there is provided a method of providing a known spectrum to a thermal gradient spectrometer having a window for receiving infrared emissions from living tissue. The method comprises affixing a standard to the window. The standard comprises a body formed from a material having known and stable spectral properties. The method further comprises placing at least a portion of the body in direct contact with the window, and operating the thermal gradient spectrometer to detect an emission spectrum of the body.

In accordance with another embodiment an infrared spectrometer comprises a window for receiving infrared energy. The window has an exposed surface. The infrared spectrometer further comprises a standard comprising a body formed of a material having known and stable spectral properties. At least part of the body is removably disposed directly against the exposed surface of the window.

In accordance with another embodiment a noninvasive optical detection system comprises a window for receiving energy from living tissue. The window has an exposed surface. The system further comprises a standard comprising a body formed of a material having known and stable spectral properties At least part of the body is disposed directly against the exposed surface of the window.

For purposes of summarizing the invention and the advantages achieved over the prior art, certain objects and advantages of the invention have been described herein above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention, certain preferred embodiments and modifications thereof will become apparent to those skilled in the art from the detailed description herein having reference to the figures that follow, of which:

FIG. 1 depicts a noninvasive absorption spectrometer;

FIG. 2 depicts the noninvasive spectrometer of FIG. 1, with a blanking standard affixed to the window in accordance with one embodiment;

FIG. 3 is a perspective view of the blanking standard of FIG. 2;

FIG. 4 is a partial elevation view of a first variation of the underside of the blanking standard;

FIG. 5 is a partial elevation view of another variation of the underside of the blanking standard;

FIGS. 6A-6C are partial cross sectional views of the attachment of the blanking standard to the spectrometer;

FIG. 7 depicts another embodiment of the blanking standard of FIG. 3; and

FIG. 8 depicts an applicator for applying a blanking standard to a spectrometer window.

### DETAILED DESCRIPTION OF THE PREFERRED EMBODIMENT

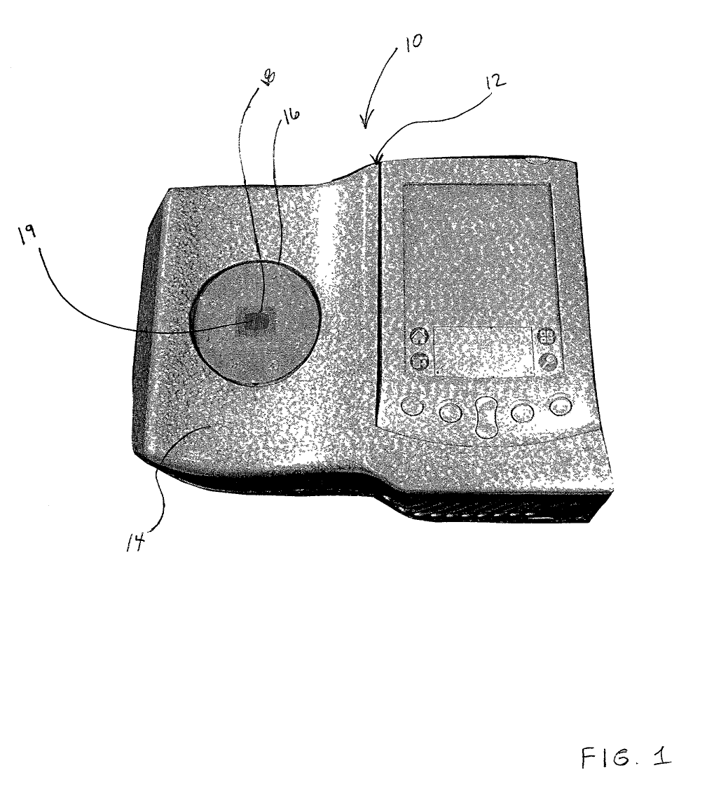

FIG. 1 depicts a noninvasive absorption spectrometer 10 of the type which may be employed to measure the concentration of certain analytes, such as glucose, within the vasculated portions of the human body. The measurement is performed by detecting the intensity of infrared energy emitted from within the body at wavelengths selected to highlight or isolate the absorptive effects of the analyte of interest.

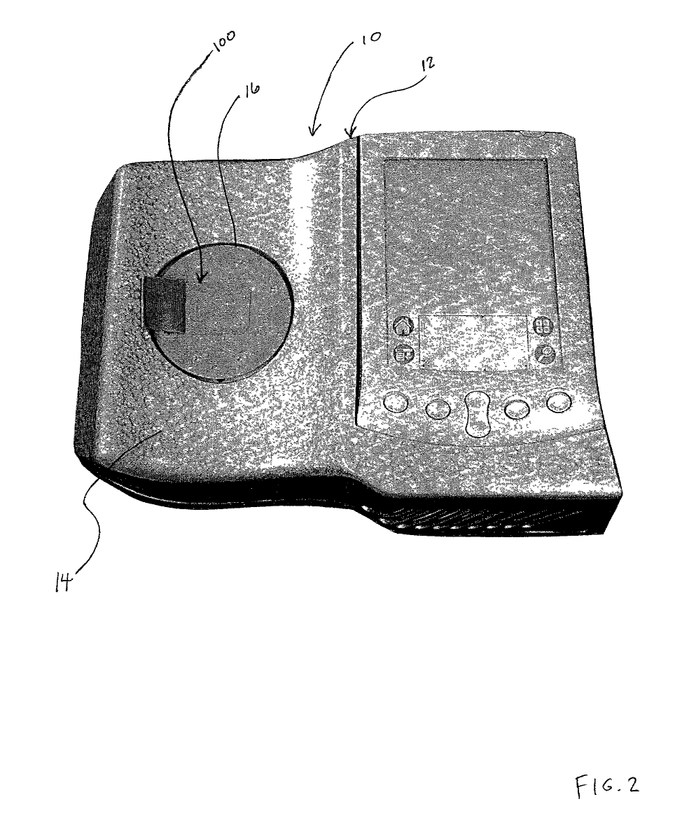

Other known types of spectrometer emit infrared or other energy into the patient's tissue and measure the reflection or return from the tissue. It is to be understood that the blanking standard and methods of use disclosed herein are not limited to use with the spectrometer 10 of FIGS. 1 and 2; rather they may be used with any noninvasive optical detection system, spectrometer or similar instrument having a window or lens for passing and/or receiving energy to or from living tissue.

The spectrometer 10 includes a chassis 12 which forms a contoured body contact surface 14 surrounding a window holder 16. A window 18 having an upper, outer or exposed surface 19 is positioned within the window holder 16 so that, upon placement of a body part, such as the forearm, upon the body contact surface 14, the upper surface 19 of the window 18 will be in contact with the skin and will permit infrared energy emitted from within the forearm to pass into the spectrometer 10 for detection and analysis. The window 18, as well as the balance of the optical path within the spectrometer 10 beneath the window 18, are formed from a material which is highly transparent to infrared wavelengths, so as to ensure optimum transmission of the emitted infrared energy to the detection systems (not shown) within the spectrometer 10.

Additional details relating to spectrometers, spectroscopy and spectrometer calibration methods may be found in the Assignee's U.S. Pat No. 6,198,949, issued Mar. 6, 2001 and titled SOLID-STATE NON-INVASIVE INFRARED ABSORPTION SPECTROMETER FOR THE GENERATION AND CAPTURE OF THERMAL GRADIENT SPECTRA FROM LIVING TISSUE; U.S. Pat. No. 6,196,046, issued Mar. 6, 2001 and titled DEVICES AND METHODS FOR CALIBRATION OF A THERMAL GRADIENT SPECTROMETER; U.S. Pat. No. 6,161,028, issued Dec. 12, 2000 and titled METHOD FOR DETERMINING ANALYTE CONCENTRATION USING PERIODIC TEMPERATURE MODULATION AND PHASE DETECTION; and U.S. Pat. No. 6,049,081, issued Apr. 11, 2000 and titled SUBSURFACE THERMAL GRADIENT SPECTROSCOPY; as well as in the Assignee's U.S. patent application Ser. No. 09/538,164, titled METHOD AND APPARATUS FOR DETERMINING ANALYTE CONCENTRATION USING PHASE AND MAGNITUDE DETECTION OF A RADIATION TRANSFER FUNCTION. The entire contents of each of the above-mentioned patents and of the above-mentioned patent application are hereby incorporated by reference herein.

FIG. 2 shows the spectrometer 10 with a blanking standard or reference standard 100 in place over the window. The blanking standard 100 preferably completely covers the window and provides/emits a known, stable emission spectrum for detection by the spectrometer 10. This known emission spectrum may be used to correct for a shift or offset that can arise in the spectrometer's measurements over time, due to instrument drift effects and the like. It is contemplated that the spectrometer 10 reads the known emission spectrum of the blanking standard 100 and the spectrometer is then tuned or adjusted so that its reading of the known emission spectrum matches the known value(s) of the spectrum, thereby correcting for any offset or error. Preferably, this “one-time” reading and adjustment step will be effective to facilitate a relatively large number of subsequent, accurate spectral readings performed on patients. Such correction is known as “blanking,” which is to be contrasted with “referencing,” in which a reference measurement is taken of a known emission spectrum before or after each measurement taken of a patient, and the measured value of the known spectrum is stored or remembered and then employed in calculating the value of the emission spectrum taken from the patient. It is contemplated that the blanking standard 100 disclosed herein can be used for both purposes.

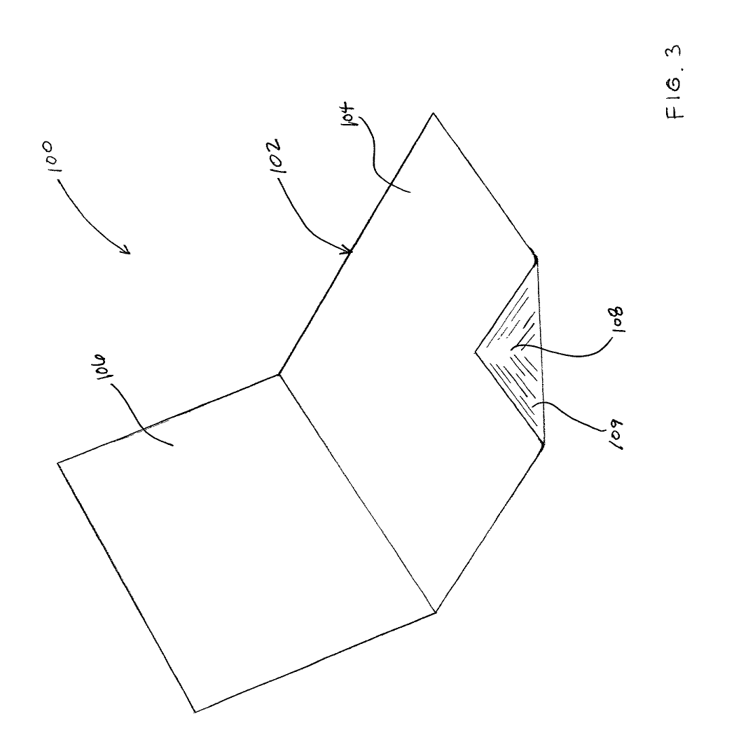

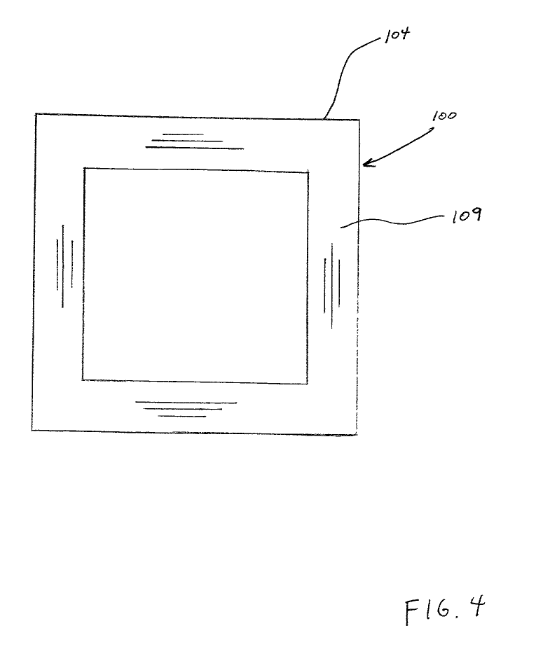

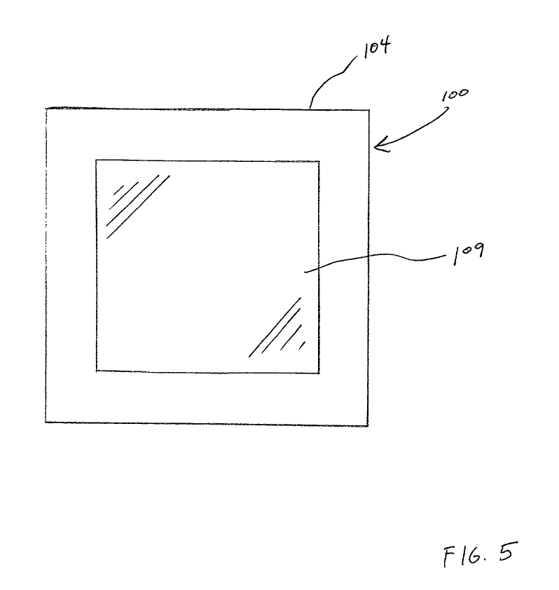

FIG. 3 shows the blanking standard 100 in greater detail. The standard 100 has a body 102 formed from a flexible, durable material having known and stable spectral properties, preferably vinyl of about 2 mils in thickness. However, those skilled in the art will appreciate that other materials and thicknesses are suitable for use in forming the body 102. It is also preferred that the body be colored or dyed to provide an absorption spectrum, for example that of carbon black, which is especially suited for the purpose of blanking as discussed above. The body 102 has a backing 104 with preferred dimensions of about 0.5″ long by about 0.3″ deep, and may preferably include a handle 106. The backing 104 has a tacky underside 108 with a layer of adhesive material 109 which is selected to have known and stable spectral properties, controlled release (i.e., not prone to leave adhesive residue when removed from the window), and selective tackiness with an affinity for body oils and dead tissue fragments. In one embodiment, the layer of adhesive material 109 is coextensive with the backing 104; in another embodiment, the layer of adhesive material covers only a portion of the backing 104, such as only the edge portions (see FIG. 4) or only the central portion (see FIG. 5) of the backing. Experimentation has thus far revealed that one suitable adhesive for use in the layer of adhesive material 109 is that employed on BLUE PAINTER'S LONG MASK TAPE available from 3M Corporation. It is contemplated that for storage and delivery purposes a number of blanking standards could be affixed to a sheet of wax paper or other “easy release” material until needed for use.

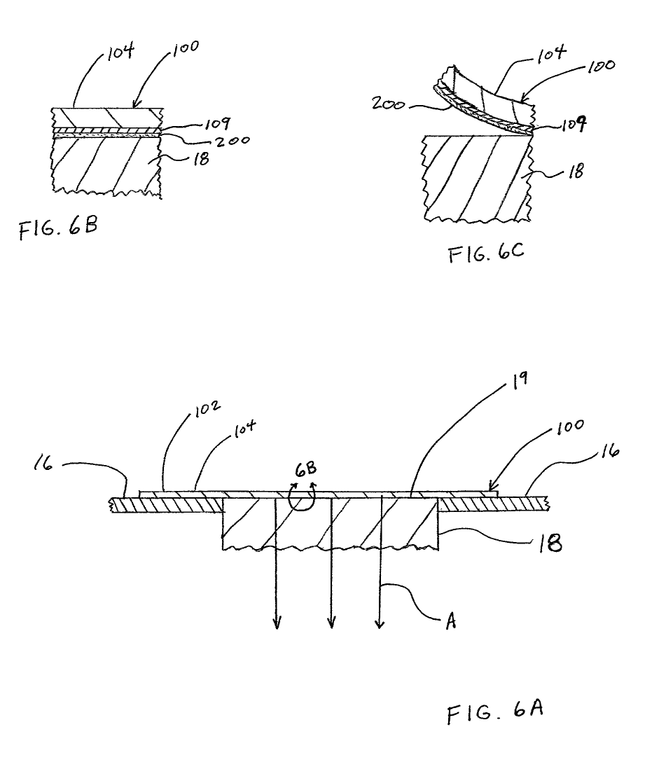

After a human measurement is made with the spectrometer 10 the subject's arm is removed from the window 18. The blanking standard 100 is then affixed to the window 18, as shown in FIGS. 2 and 6A. In particular, the body 102, including the backing portion 104 of the blanking standard 100, is placed/applied directly to, or directly against, the upper surface 19 of the window 18. It is advantageous to apply the standard 100 directly to the window 18 in order to provide optimal thermal and/or optical coupling between the standard and the window, and by extension between the standard and the detector systems of the spectrometer. This optimal coupling results from the minimization of material and space between the standard and the window. In addition, the direct contact facilitates a cleaning function of the standard as will be discussed in further detail below.

The body 102/backing 104 is adhered to the upper surface 19 and/or to the adjacent portions of the spectrometer 10 (such as the window holder 16) by the adhesive material 109 on the tacky underside thereof. A measurement of the known spectral properties of the blanking standard 100 may then be made with the blanking standard 100 in place, by allowing the emission spectrum of the standard 100, represented by the arrows A in FIG. 6A, to pass through the window 18 and into the spectrometer, and operating the spectrometer to read the spectrum of the standard in the usual manner. Since the standard 100 has a known and stable spectral property this measurement can be used to determine and correct for any offset or error in the operation of the spectrometer 10, and/or to reference a human spectral measurement just taken, or to be taken subsequently.

FIG. 6B is a magnified view of the contact between the backing portion 104 of the standard 100, showing the adhesive layer 109 on the underside of the backing 104. (However, as discussed above, the adhesive layer 109 need not be present on that portion of the backing 104 which covers or contacts the upper surface 19 of the window 18.) FIG. 6B also shows a layer 200 of contaminants, such as body oils and/or skin fragments left behind on the window 18 when the skin of a human subject was previously in contact with the window 18. This layer 200 introduces the same bias, offset or error into the reference measurement taken of the standard 100 as the oils/skin did when taking the measurement of the subject's arm. This bias, when present in both the human and reference/blanking measurements, can be accounted for or canceled out in the referencing and/or blanking process, further promoting improved accuracy. The reference measurement can also be used to correct for instrument drift prior to computation of human analyte concentrations such as that of glucose. The blanking standard 100 is preferably left in place on the window 18 until the next human measurement is desired; because the standard covers the window during that period it also protects the window from abrasion and damage.

As seen in FIG. 6C, the contaminant layer 200 is advantageously cleaned from the window 18 when the standard 100 is removed, as the contaminants adhere to the adhesive layer 109 (where present on the backing 104) when the backing is peeled from the window 18. Thus a clean window is available for use immediately upon removal of the standard 100, which is preferably done just prior to taking the next human measurement. Upon removal of the blanking standard 100, the body oils and/or skin fragments left behind on the window 18 after the last measurement adhere to the tacky underside of the blanking standard; thus the standard simultaneously cleans the window during ordinary use, preserving its transparency to infrared energy. The blanking standard is preferably disposed of after removal from the window. After the next human measurement is complete a new blanking standard may be applied to the window, to protect the window from scratches and/or to once again provide a known spectrum for blanking or reference purposes.

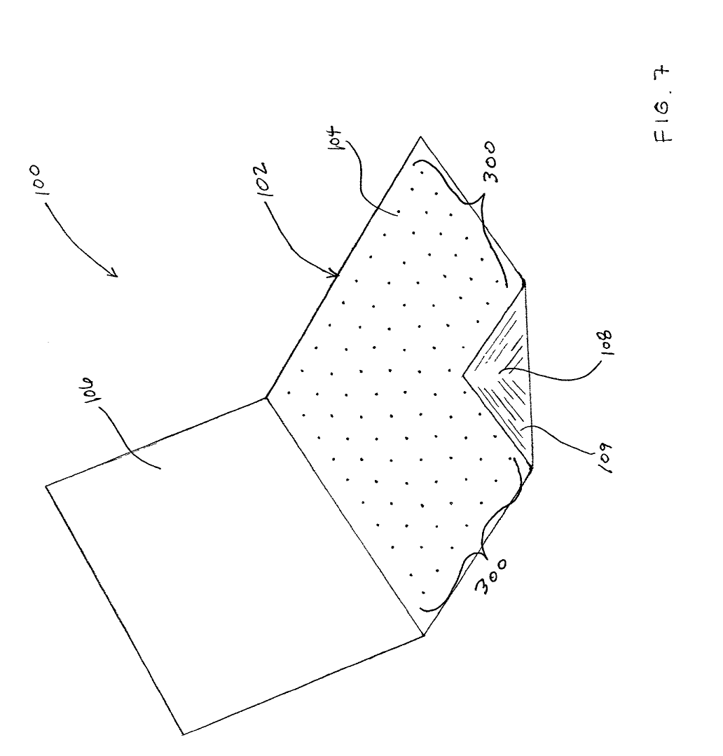

In a further embodiment, shown in FIG. 7, a number of small airholes 300 are formed in the backing 104. The airholes 300 advantageously prevent the retention of air bubbles between the blanking standard 100 and the device window upon application of the standard thereto. The presence of such air bubbles can distort the emission spectrum read by the detector and it is thus desirable to eliminate them in order to preserve overall device accuracy.

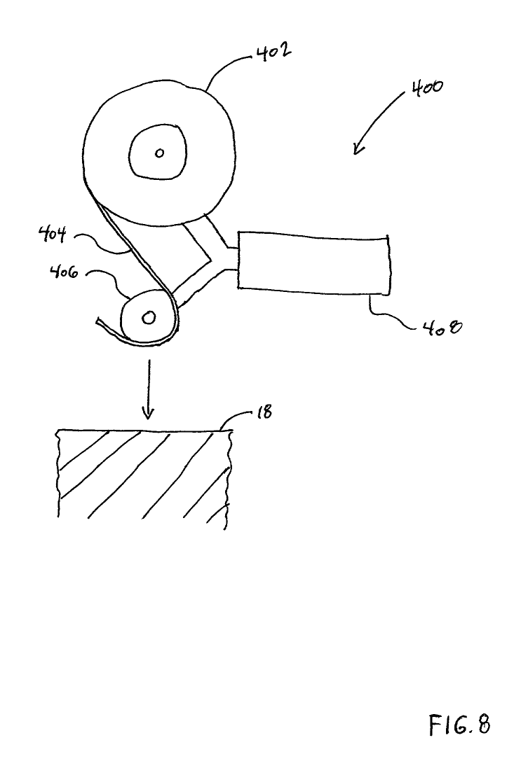

FIG. 8 depicts an applicator 400 which may be used to apply a blanking standard to the device window 18. The applicator 400 holds a roll 402 of blanking standards 404 connected end-to-end in “tape” form. The standards 404 extend from the roll 402 and around a pressure roller 406 so that the adhesive side of the standards faces away from the roller 406. Thus, when the user grips the handle 408, he or she can press the standard 404 against the window 18 with the roller 406 while simultaneously applying the standard thereto by advancing the roller 406 across the window 18. The simultaneous application of pressure inhibits the retention of air bubbles between the window and the standard during application of the standard.

In the roll 402, the individual blanking standards may be separated by perforation to facilitate tearing away when a standard has been applied to the window 18. The user may do this by applying thumb pressure to the roll 402, thereby “braking” the roll and inducing tension in the portion of the standards 404 extending from the roll 402. Alternatively, the roll of blanking standards may be non-perforated, and a blade (not shown) may be incorporated in the applicator 400 to enable the user to cut the standard loose upon application to the window. It is contemplated that the applicator 400 may be used with blanking standards with or without the airholes 300 depicted in FIG. 7 and described above.

As a further alternative, a simple hand roller can be used to press a “single” blanking standard (of the type depicted in FIG. 3 or FIG. 7) to the window and eliminate any air bubbles between the window and the standard.

The blanking standard 100 can also be used at any time to simply test for and/or correct any offset or error that may have arisen in the spectrometer, without performing a human measurement at that time. In this method the standard is applied to the window under the procedures discussed above, but without performing any associated human measurements.

Thus it will be appreciated that the blanking standard disclosed herein simultaneously provides (1) an effective “known” spectrum for device drift correction and/or referencing a human measurement, with optimal thermal/optical coupling between the standard and the instrument; (2) quick and easy cleaning of the device window which in turn facilitates high accuracy and repeatability in taking measurements; and (3) protection of the window against abrasion and other damage, further preserving the optical characteristics of the window and the accuracy of the device as a whole.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. A method of providing a known spectrum to a noninvasive optical detection system of the type having a window for receiving infrared energy, the method comprising:
affixing a standard to said window, said standard comprising a body formed from a material having known and stable spectral properties;
placing at least a portion of said body directly against said window; and
operating said optical detection system to detect an emission spectrum of said body.

2. The method of claim 1, wherein:
said standard further comprises an adhesive layer on at least one side of said body; and
placing at least a portion of said body directly against said window comprises adhering at least a portion of said body to an upper surface of said window with said adhesive layer.

3. The method of claim 1, wherein said emission spectrum of said body is substantially the same as that of carbon black.

4. The method of claim 1, wherein placing at least a portion of said body directly against said window comprises completely covering said window with said body.

5. The method of claim 1, further comprising pressing said body against said window so as to prevent the retention of air bubbles between said body and said window.

6. The method of claim 5, wherein pressing said body against said window comprises pressing a roller against said body.

7. The method of claim 5, wherein pressing said body against said window comprises pressing a roller of a standard applicator against said body.

8. The method of claim 1, further comprising:
removing said standard from said window;
placing living tissue against said window; and
operating said optical detection system to detect an emission spectrum of said living tissue.

9. The method of claim 1, wherein:
said standard further comprises an adhesive layer on at least one side of said body;
placing at least a portion of said body directly against said window comprises adhering at least a portion of said body to an upper surface of said window and to contaminants disposed on said upper surface, with said adhesive layer; and
said method further comprises cleaning contaminants from said upper surface by removing said standard from said window.

10. The method of claim 1, wherein said noninvasive optical detection system comprises a thermal gradient spectrometer.

11. The method of claim 1, wherein said standard comprises a blanking standard.

12. The method of claim 1, wherein said standard comprises a reference standard.

13. A method of providing a known spectrum to a thermal gradient spectrometer having a window for receiving infrared emissions from living tissue, the method comprising:
affixing a standard to said window, said standard comprising a body formed from a material having known and stable spectral properties;
placing at least a portion of said body in direct contact with said window; and
operating said thermal gradient spectrometer to detect an emission spectrum of said body.

14. The method of claim 13, wherein:
said standard further comprises an adhesive layer on at least one side of said body; and
placing at least a portion of said body in direct contact with said window comprises adhering at least a portion of said body to an upper surface of said window with said adhesive layer.

15. The method of claim 13, wherein said emission spectrum of said body is substantially the same as that of carbon black.

16. The method of claim 13, wherein placing at least a portion of said body in direct contact with said window comprises completely covering said window with said body.

17. The method of claim 13, further comprising:
removing said standard from said window;
placing living tissue against said window; and
operating said thermal gradient spectrometer to detect an emission spectrum of said living tissue.

18. The method of claim 13, wherein:
said standard further comprises an adhesive layer on at least one side of said body;
placing at least a portion of said body in direct contact with said window comprises adhering at least a portion of said body to an upper surface of said window and to contaminants disposed on said upper surface, with said adhesive layer; and
said method further comprises cleaning contaminants from said upper surface by removing said standard from said window.

19. An infrared spectrometer comprising:
a window for receiving infrared energy, said window having an exposed surface; and
a standard comprising a body formed of a material having known and stable spectral properties, at least part of said body being removably disposed directly against said exposed surface of said window.

20. The spectrometer of claim 19, wherein said standard further comprises an adhesive layer on at least one side of said body, said adhesive layer adhering said body to said window.

21. The spectrometer of claim 19, wherein said body is formed from vinyl.

22. The spectrometer of claim 19, wherein said body has an emission spectrum which is substantially the same as that of carbon black.

23. The spectrometer of claim 19, wherein said body completely covers said exposed surface of said window.

24. A noninvasive optical detection system comprising:
a window for receiving energy from living tissue, said window having an exposed surface;
a standard comprising a body formed of a material having known and stable spectral properties, at least part of said body disposed directly against said exposed surface of said window.

25. The noninvasive optical detection system of claim 24, wherein said standard further comprises an adhesive layer on at least one side of said body, said adhesive layer adhering said body to said window.

26. The noninvasive optical detection system of claim 24, wherein said body is formed from vinyl.

27. The noninvasive optical detection system of claim 24, wherein said body includes a number of airholes.

28. The noninvasive optical detection system of claim 24, wherein said body has an emission spectrum which is substantially the same as that of carbon black.

29. The noninvasive optical detection system of claim 24, wherein said body completely covers said exposed surface of said window.
